(19) United States
(12) Patent Application Publication
(10) Pub. No.: US 2005/0272497 A1
(43) Pub. Date: Dec. 8, 2005

(54) Sports videogame including user customized playing areas earned through gameplay

(75) Inventors: Henry Sterchi, Kirkland, WA (US); Jeff Miller, Bellevue, WA (US); Dan Tudge, Parksville (CA); Art We, Parksville (CA); Glen Schulz, Qualicum Beach (CA); Craig Williams, Parksville (CA); Neil Hill, Parksville (CA)

Correspondence Address: NIXON & VANDERHYE, P.C., 901 NORTH GLEBE ROAD, 11TH FLOOR, ARLINGTON, VA, 22203, US

(73) Assignee: Nintendo of America Inc., Redmond, WA (US)

(21) Appl. No.: 10/920,439

(22) Filed: Aug. 18, 2004

Related U.S. Application Data
(60) Provisional application No. 60/569,248, filed on May 10, 2004.

(51) Int. Cl. A63F 13/00

(52) U.S. Cl. 463/3

(57) ABSTRACT

A sports videogame generates and displays a playing area having user customized upgrade features as a reward for a user's gameplay of the videogame. The user earns user customized upgrade features by engaging in gameplay in different gameplay modes or satisfying gameplay performance goals. The user may earn the option of playing a game using the playing area having the user customized upgrade features after a predetermined percentage of the available upgrades to the playing area is earned.

### CROSS REFERENCE TO RELATED APPLICATION

The present application claims priority from U.S. Provisional Application No. 60/569,248 (Attorney Ref. No. 723-1471) filed May 10, 2004, the content of which is incorporated herein by reference.

### BACKGROUND AND SUMMARY

The technology herein relates to the field of sports videogames and, more particularly, to a sports videogame which generates and displays a user customized playing area (e.g., playing field, rink or court) as a reward for gameplay of the videogame. For example, exemplary implementations generate and display user customized upgrades of a playing area as a reward for engaging in gameplay in different gameplay modes (e.g., franchise, season, tournament modes) and/or for achievements within gameplay (e.g., wining a particular number of games or achieving a certain winning percentage).

Sports videogames have been very successful and popular in the past. There are a variety of sports games that have been provided for use on videogame consoles, such as Nintendo's N64, Sega's Dreamcast, and Sony's Playstation2, to name just a few as well as the Game Boy Advance (GBA) portable game console. Numerous basketball, football, soccer, baseball and hockey games, as well as many other sports games, have been created for playing on videgame consoles. Due mainly to the major advancements in graphics hardware over the years, these sports videogames have become very realistic and provide users of the games with an exciting and enjoyable experience that closely simulates real sports competition. The software behind these videogames has also become very sophisticated and facilitates many elements of real sports competition in order to provide the user with an experience that simulates real sports play as close as possible. For example, in baseball videogames, the player is provided with the ability to pitch, throw, hit, field, catch and perform many other simulated acts that a real-life baseball player would perform during an actual real-life game.

While prior videogames provide exciting gameplay, the industry is constantly striving to improve the games and provide even more exciting experiences for the player. Constant improvements are needed in order to continue to satisfy the ever increasing demand for high quality and exciting sports videogames. One way that sports videogame developers have generated excitement and interest in sports videogames is to provide the user the option of playing in different gameplay modes. These different gameplay modes include, for example: (i) a season mode in which a user selects a desired team which competes against other teams in a simulated season with won-lost and player statistics being updated via play during the season, (ii) a franchise mode which places the user in the position of a team franchise general manager capable of trading and drafting players, and (iii) a tournament mode which allows a user to define a single elimination or round-robin tournament between teams and/or users.

Despite having the option of playing in many different gameplay modes, some users may limit their play to only a few or even a single mode of gameplay. Those users would thus not experience the full enjoyment of various gameplay capable of being provided by the videogame. It would therefore be beneficial to provide incentives to users to play in different modes of the videogame and to lengthen their gameplay time. Providing such incentives would increase interest in the videogame.

Exemplary implementations of the sports videogame disclosed herein resolve this problem. In particular, exemplary implementations of the sports videogame provide user customizable playing areas (e.g., playing fields, courts, rinks, stadiums etc.) each having upgrade features that may be incrementally earned through gameplay. The potential upgrades correspond to the user's particular tastes. A particular upgrade may be associated with selection and play of the videogame in a certain gameplay mode so that the upgrade is only earned by the user upon selection and play in that gameplay mode. The earned upgrade will later be displayed to the user as part of the user customized playing area. The user earns additional upgrades to even further customize the playing area by selecting and entering other gameplay modes and/or achieving certain performance goals such as winning a certain number of games. Once the customization of the playing field progresses beyond a target completion percentage, the user gains the option of playing games in the customized playing area. Once the customization of the playing area progresses beyond the target completion percentage, the videogame generates and displays another playing area which, like the original playing field, may be user customized with upgraded features earned through play in various gameplay modes and/or completion of performance goals.

The user customized upgrades to a playing surface provides an incentive for the user to continue playing the videogame, and in particular provides an incentive to engage in play in different gameplay modes. The user develops the satisfaction of knowing that his/her efforts are being rewarded and can see the playing field developing in a step-wise fashion through continued play. The user may ultimately gain the option of playing in this developed field, a field which reflects the user's achievements and/or favorite tastes, colors, players etc. The user's interest and excitement in playing the videogame is therefore enhanced.

In an exemplary non-limiting implementation, in a sports videogame having a plurality of different gameplay modes, wherein animated action is performed by at least one videogame character in response to input by a user provided through a user-operable controller, a method comprises: receiving user input on the user-operable controller which selects a particular one of the plurality of gameplay modes, each of the gameplay modes being associated with a respective upgrade to a playing area; awarding the user an upgrade to the playing area based on the gameplay mode selected by the received user input; and providing the user the option of engaging in gameplay in which animated action is performed by the videogame character in the playing area having the awarded upgrade. The option of engaging in gameplay in which animated action is performed by the videogame character in the playing area having the awarded upgrade may be provided only after the user has been awarded at least a predetermined percentage of upgrades to the playing area. At least one upgrade may relate to a user-customized preference that has been input by the user. The user-customized preference that has been input by the user may relate to a particular color, sports-team, athlete or athletic accomplishment. The method may further comprise generating a display of the playing area showing at least one upgrade awarded to the user prior to providing the user the option of engaging in gameplay using the playing area. The method may further comprise generating a display of the playing area showing at least one upgrade which has not been awarded to the user. The upgrade to the playing area may be awarded to the user only after the user engages in gameplay in the selected gameplay mode. After the user has been provided the option of engaging in gameplay in which animated action is performed by the videogame character in the playing area having the awarded upgrade, the method may further comprise: receiving user input on the user-operable controller which selects a particular one of the plurality of gameplay modes, each of the gameplay modes being associated with a respective upgrade to another playing area; awarding the user an upgrade to the another playing area based on the gameplay mode selected by the received user input; and providing the user the option of engaging in gameplay in which animated action is performed by the videogame character in the another playing area having the awarded upgrade to the another playing area.

In another exemplary non-limiting implementation, in a sports videogame having a plurality of different gameplay modes, wherein animated action is performed by at least one videogame character in response to input by a user provided through a user-operable controller, a method comprises: receiving user input on the user-operable controller which selects a particular one of the plurality of gameplay modes, each of the gameplay modes being associated with a respective upgrade to a playing area; awarding the user an upgrade to the playing area based on the gameplay mode selected by the received user input; determining whether or not the user has been awarded at least a predetermined number of upgrades to the playing area; and providing gameplay in which the user controls the videogame character in the playing area having the awarded upgrades so that animated action is performed using the playing area having the awarded upgrades after the determination has been made that the user has been awarded at least the predetermined number of upgrades to the playing area. The method may further comprise providing the user an option of engaging in the gameplay in which the user controls the videogame character in the playing area having the awarded upgrades, and generating a display of the playing area showing the upgrades awarded to the user, the display being generated prior to providing the user the option.

Another exemplary non-limiting implementation relates to a method of controlling gameplay in a sports videogame having a plurality of gameplay modes, wherein a user controls a videogame character in response to input by a user provided through a user-operable controller, the method comprising: receiving user input through the user-operable controller to select a first gameplay mode to enable gameplay in the first gameplay mode; awarding the user a first upgrade to a playing area based on the selection of the first gameplay mode; receiving user input through the user-operable controller to select a second gameplay mode to enable gameplay in the second gameplay mode; awarding the user a second upgrade to the playing area based on the selection of the second gameplay mode; and providing gameplay in which the user controls the videogame character in the playing area having the first and second upgrades so that animated action is performed by the videogame character in the playing area having the first and second upgrades. The gameplay in which animated action is performed by the videogame character in the playing area having the first and second upgrades may be presented to the user as a user-selectable option after the user has been awarded a predetermined number of upgrades to the playing area. The method may further comprises providing the user an option of selecting the gameplay in which animated action is performed in the playing area having the first and second upgrades, and generating a display of the playing area showing the first and second upgrades prior to providing the user of the option of selecting the gameplay in which animated action is performed in the playing area having the first and second upgrades. The method may further comprise generating a display, prior to providing gameplay in which animated action is performed by the videogame character in the playing area having the first and second upgrades, which shows one or more of the first and second upgrades. The first upgrade may be awarded to the user only after the user engages in gameplay in the first gameplay mode selected by the user input, and the second upgrade is awarded to the user only after the user engages in gameplay in the second gameplay mode selected by the user input.

In another exemplary non-limiting implementation, in a sports videogame having a plurality of different gameplay modes, wherein animated action is performed by at least one videogame character in response to input by a user provided through a user-operable controller, a method comprises: receiving user input on the user-operable controller selecting one of the plurality of gameplay modes; awarding the user a predetermined number of point(s) based on each of the gameplay modes selected by the user input; accumulating the number of points that have been awarded to the user; determining whether or not the accumulated number of points meets or exceeds a threshold number of points; and providing the user a gameplay option in which the user controls the videogame character in a playing area having at least one user customized feature if the accumulated number of points meets or exceeds the threshold number of points. The number of points awarded to the user based on the user's first selection of a particular one of the gameplay modes may be equal to a first number and the number of point(s) awarded to the user based on the user's subsequent re-selection of the same particular one of the gameplay modes may be equal to a lesser number points than the first number. The number of points awarded to the user based on an initial selection of any one of the gameplay modes may be equal to N, and the number of points awarded to the user for a subsequent re-selection of a same one of any of the gameplay modes may be equal to M, M being less than N.

In another exemplary non-limiting implementation, in a sports videogame, wherein animated action is performed by at least one videogame character in response to input by a user provided through a user-operable controller, a method comprises: detecting the user's satisfaction of one of a plurality of gameplay performance goals, each gameplay performance goal being associated with a respective upgrade to a playing area; awarding to the user the upgrade to the playing area associated to the gameplay performance goal satified by the user; and providing the user the option of engaging in gameplay in which animated action is performed by the videogame character in the playing area having the awarded upgrade. The option of engaging in gameplay in which animated action is performed by the videogame character in the playing area having the awarded upgrade may be provided only after the user has been awarded a predetermined percentage of upgrades to the playing area. At least one upgrade may relate to a user-customized preference that has been input by the user. The user-customized preference that has been input by the user may relate to a particular color, sports-team, athlete or athletic accomplishment. The method may further comprise generating a display of the playing area showing the upgrade(s) that have been awarded to the user prior to providing the user the option of engaging in gameplay using the playing area. The method may further comprise generating a display of the playing area showing at least one upgrade which has not been awarded to the user. After the user has been provided the option of engaging in gameplay in which animated action is performed by the videogame character in the playing area having the awarded upgrade, the method may further comprise: detecting the user's satisfaction of one of a plurality of gameplay performance goals each of which is associated with a respective upgrade to another playing area; awarding to the user the upgrade to the another playing area associated to the gameplay performance goal satisfied by the user; and providing the user the option of engaging in gameplay in which animated action is performed by the videogame character in the another playing area having the awarded upgrade.

In another exemplary non-limiting implementation, in a sports videogame, wherein animated action is performed by at least one videogame character in response to input by a user provided through a user-operable controller, a method comprises: receiving user input on the user-operable controller to control the videogame character in gameplay of the videogame; determining the user's satisfaction of at least one of a plurality of gameplay performance goals each of which is associated with a respective upgrade to a playing area; awarding to the user the upgrade to the playing area associated to each gameplay performance goal satisfied by the user; determining whether or not the user has been awarded a predetermined number of the upgrades to the playing area; and providing gameplay in which the user controls the videogame character in the playing area having the awarded upgrades so that animated action is performed by the videogame character in the playing area after the determination has been made that the user has been awarded a predetermined number of upgrades to the playing area. The method may further comprise providing the user an option of engaging in the gameplay in which the user controls the videogame character in the playing area having the awarded upgrades, and generating a display of the playing area showing the upgrade(s) awarded to the user, the display being generated prior to providing the user the option. The method may further comprise generating a display of the playing area showing at least one upgrade which has been awarded to the user and at least one upgrade that has not been awarded to the user.

Another exemplary non-limiting implementation relates to a method of controlling gameplay in a sports videogame, wherein a user controls a videogame character in response to input by a user provided through a user-operable controller, the method comprising: receiving user input on the user-operable controller to control the videogame character in gameplay of the videogame; determining the user's satisfaction of a first gameplay performance goal; awarding the user a first upgrade to a playing area based on the user's satisfaction of the first gameplay performance goal; determining the user's satisfaction of a second gameplay performance goal; awarding the user a second upgrade to the playing area based on the user's satisfaction of the second gameplay performance goal; and providing gameplay in which the user controls the videogame character in the playing area having the first and second upgrades so that animated action is performed by the videogame character in the playing area having the first and second upgrades. The gameplay in which animated action is performed by the videogame character in the playing area having the first and second upgrades may be presented to the user as a user-selectable option after the user has been awarded a predetermined number of upgrades to the playing area. The method may further comprise providing the user an option of selecting the gameplay in which animated action is performed in the playing area having the first and second upgrades, and generating a display of the playing area showing the first and second upgrades prior to providing the user of the option of selecting the gameplay. The method may further comprise generating a display, prior to providing gameplay in which animated action is performed by the videogame character in the playing area having the first and second upgrades, which shows one or more of the first and second upgrades.

In another exemplary non-limiting implementation, in a sports videogame, wherein animated action is performed by at least one videogame character in response to input by a user provided through a user-operable controller, a method comprises: receiving user input on the user-operable controller to control the videogame character in gameplay of the videogame; determining the user's satisfaction of at least one of a plurality of gameplay performance goals; awarding the user a predetermined number of point(s) based on each of the gameplay performance goals satisfied by the user; accumulating the number of points that have been awarded to the user; determining whether or not the accumulated number of points meets or exceeds a threshold number of points; and providing the user a gameplay option in which the user controls the videogame character in a playing area having at least one user customized feature if the accumulated number of points meets or exceeds the threshold number of points.

### BRIEF DESCRIPTION OF THE DRAWINGS

These and other features, objects and advantages will be better understood from review of the following detailed description when read in conjunction with the following drawings, in which:

FIG. 1 shows an exemplary game console for use in playing videogames and a game controller for enabling a user to control operation of the game.

FIGS. 2A-2E shows a portable game system GBA which may be used as a controller to the game console illustrated in FIG. 1.

FIG. 3 shows the portable game system GBA connected as a controller to the game console illustrated in FIG. 1.

FIG. 4 is a flow diagram illustrating a method of a sports (e.g., baseball) videogame which includes the generation and display of a user customized playing area which is earned through gameplay in accordance with an exemplary non-limiting illustrative implementation. The baseball videogame may be executed by any of the game consoles illustrated in FIGS. 1-4.

FIG. 5 is a menu screen of an exemplary non-limiting illustrative baseball videogame showing a user customizable playing field having a potential upgrade associated with selection of a particular gameplay mode.

FIG. 6 is a menu screen of the exemplary non-limiting illustrative baseball videogame showing the user customizable playing field having a potential upgrade associated with selection of a particular gameplay mode different from that shown in FIG. 5.

FIG. 7 is a menu screen of the exemplary non-limiting illustrative baseball videogame showing a playing field which has been partially customized with an upgrade as a reward for previous gameplay and which shows a potential upgrade associated with selection of a particular gameplay mode.

FIG. 8 is a screen shot of the exemplary non-limiting illustrative baseball videogame showing a fully customized playing field.

FIG. 9 is a menu screen of the exemplary non-limiting illustrative baseball videogame showing a second, higher level, user customizable playing field having a potential upgrade associated with selection of a particular gameplay mode.

FIG. 10 is a menu screen of an exemplary non-limiting illustrative baseball videogame showing the second, higher level, user customizable playing field which has been partially customized with an upgrade as a reward for previous gameplay and which shows a potential upgrade associated with selection of a particular gameplay mode.

### DETAILED DESCRIPTION OF EXEMPLARY NONLIMITING ILLUSTRATIVE IMPLEMENTATIONS

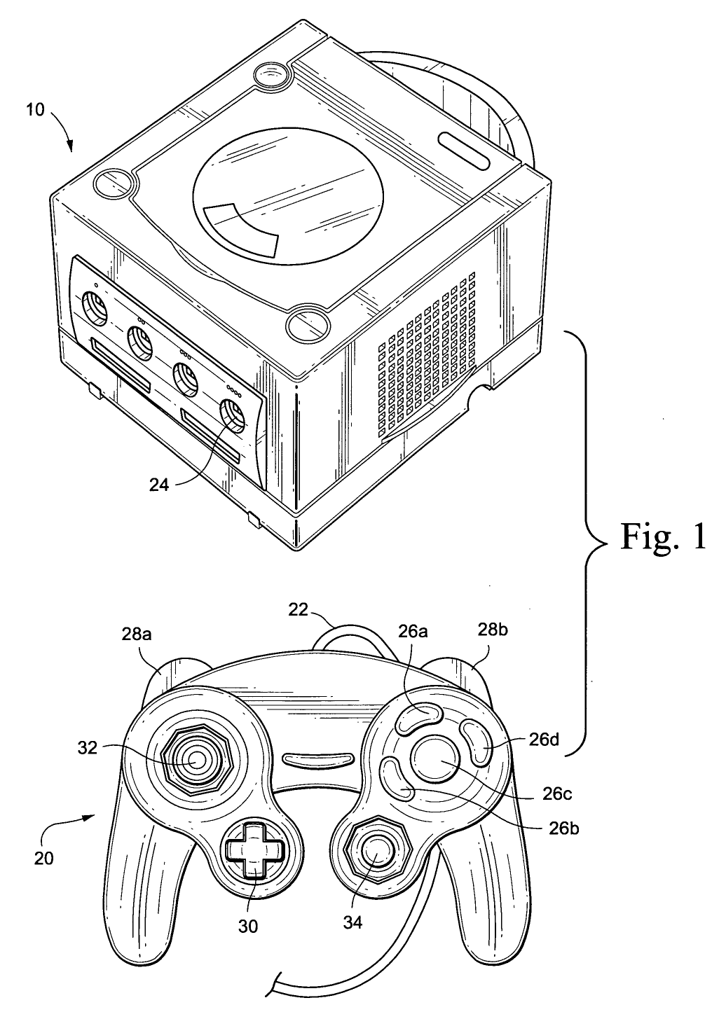

Exemplary illustrative non-limiting implementations will now be described with reference to the drawings. FIG. 1 shows a videogame console 10 that can be used to run videogames implementing user customization control features. While the NINTENDO GAMECUBE (GCN) videogame console is shown in FIG. 1, the exemplary illustrative non-limiting implementations can include any suitable game or other platform capable of running sports games, including for example PC based games incorporating a game controller. In the videogame console 10 of FIG. 1, a memory medium, such as a CD or DVD, is used to store videogame software. The software containing disk or other storage medium is placed in the console for controlling the operation thereof and enabling a desired game to be played on the console. The console preferably includes a graphics co-processor in addition to the central processing unit (CPU) in order to enable fast action games to be played and displayed in a very realistic and exciting manner. The console is typically connected to a display device, such as a television.

The videogame console is also provided with a game controller 20 for use by the user in controlling the game by providing input to the console 10 through selective operation of the buttons and other control elements on the controller 20. The controller 20 may be connected by wire 22 to the console 10 via the connection port 24, although a wireless connection or any other operable connection may be used. The controller 20 includes several different buttons that provide various corresponding signals to the videogame console for use by the game software to control the game in accordance therewith. More particularly, the exemplary controller 20 of FIG. 1 includes a cluster of four digital buttons 26a-26d, two analog buttons 28a and 28b, a joypad 30, a first analog joystick 32 and a second analog joystick 34, as well as other control elements, such as a start/stop button. One or more of the buttons, joypad or joysticks may be operated by the user and used to implement the user customization features, as will be explained in detail below. The connection port 24 may be connectable to other devices such as a microphone to receive audio signals such as the user's voice. The connection to the microphone may be made through a wire, although a wireless communication microphone may be used.

The exemplary implementations have particular applicability to sports videogames in which several (or at least two) different actions can be taken in a given situation. Such games include but are not limited to basketball, baseball, golf, volleyball, soccer, football and hockey. The exemplary illustrative non-limiting game software implementation is programmed to respond to signals from the controller 20, such that operation of one or more of the buttons or switches dictates the user's customization of the videogame. The buttons and/or switches also operate in a conventional manner to control gameplay as one skilled in the art will readily understand.

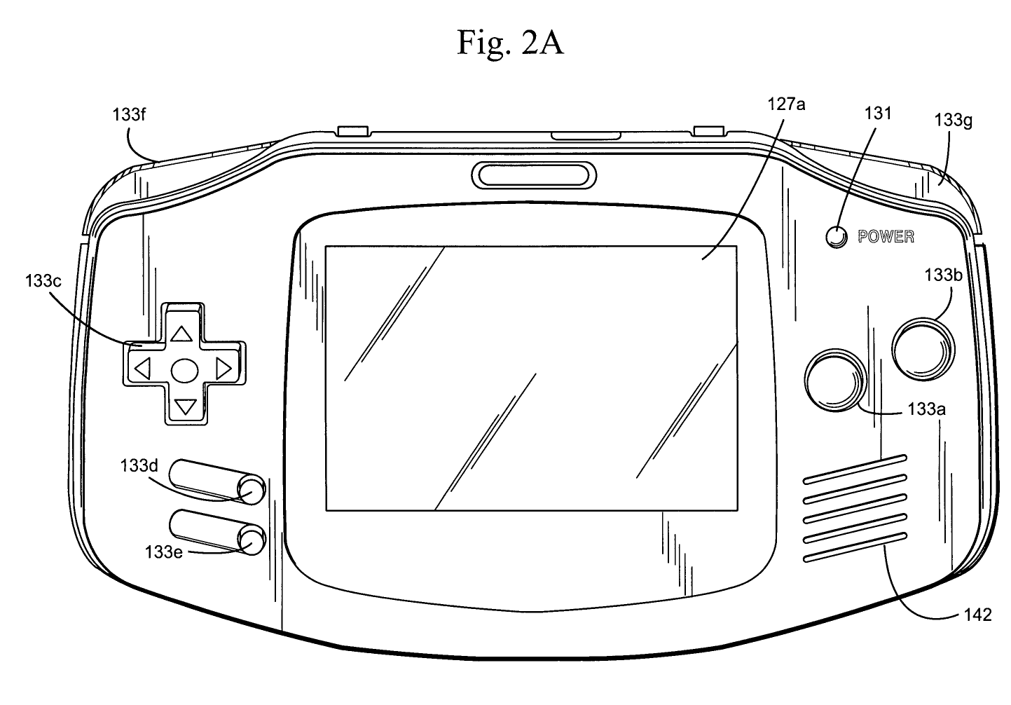

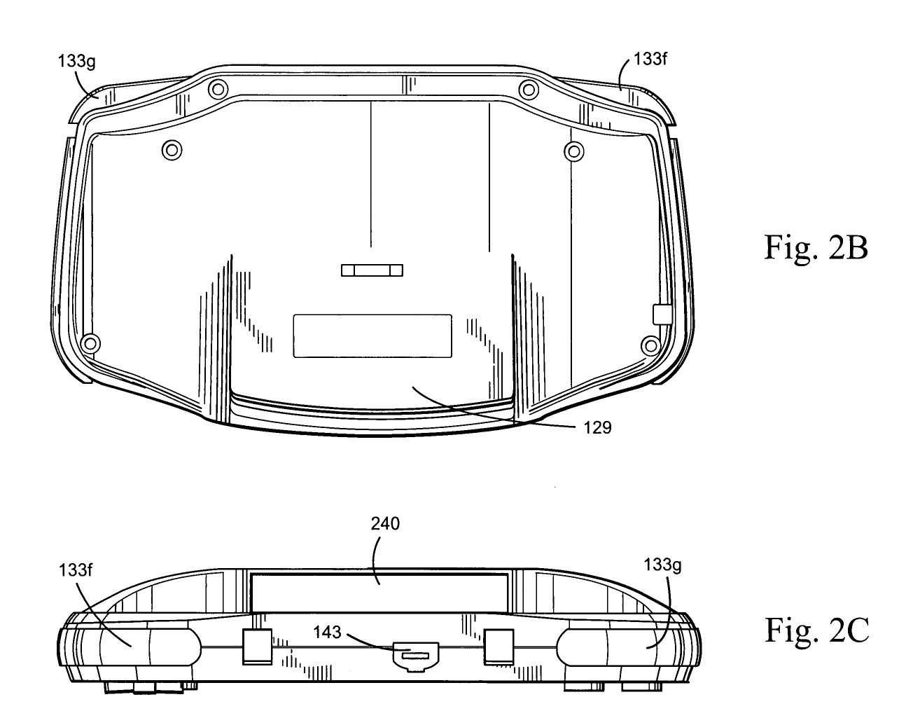

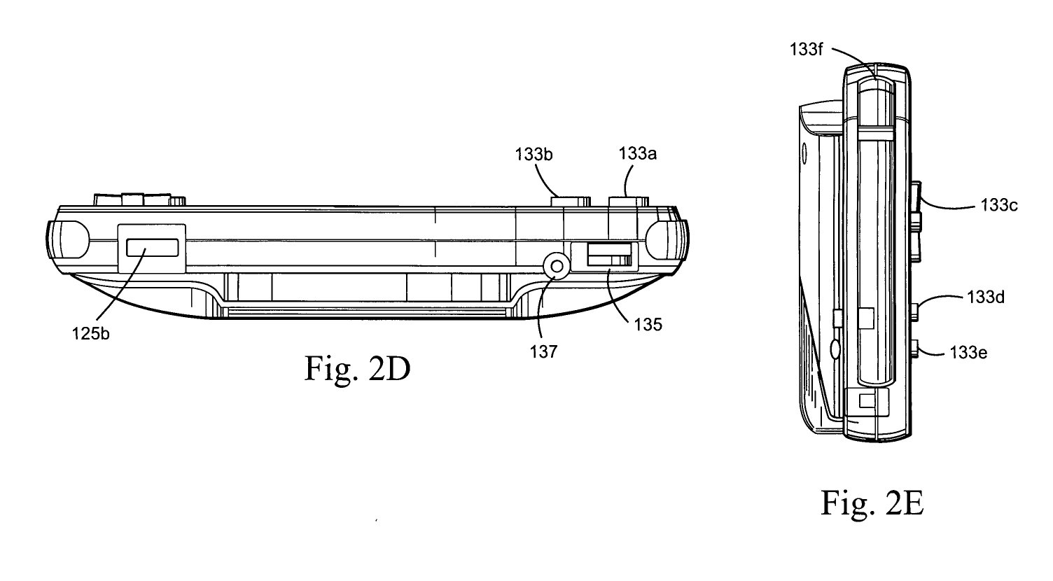

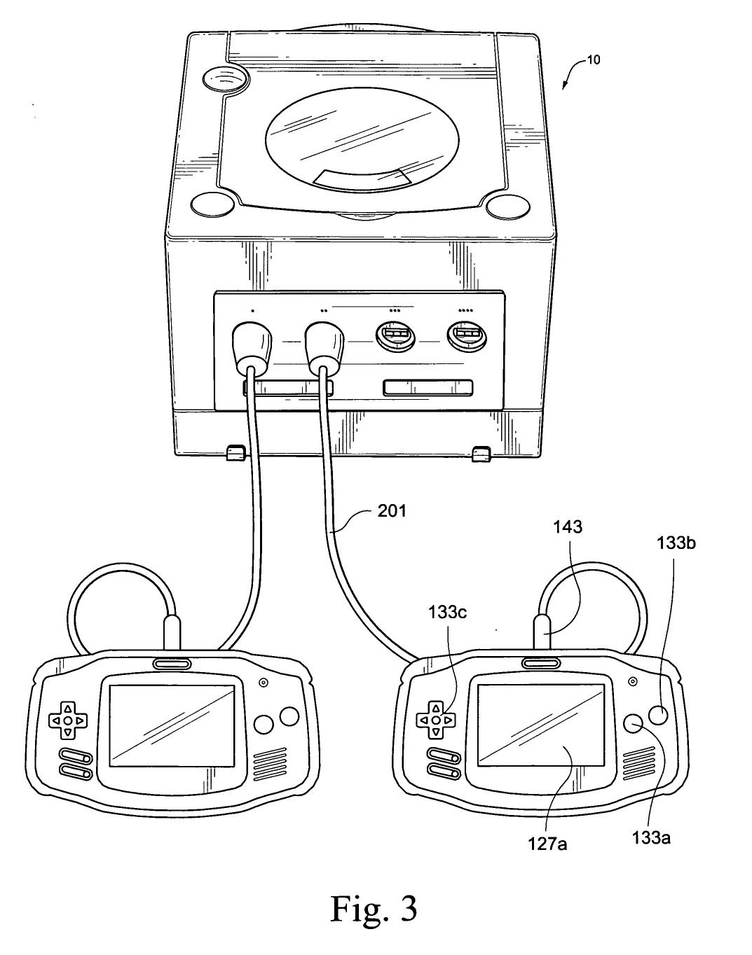

FIGS. 2A-2E are a front perspective view, a rear perspective view, a top-down view, a bottom-up view and a side view, respectively, of an example portable game system GBA. The GBA can be used to play interactive videogames with accompanying sound. It can also be used for a variety of other applications including, but not limited to, an address book, a calculator, a date book, and an e-mail application. Video is displayed on display 127a and the sound is output through speaker 142. Display 127a may, for example, be a reflection (non-backlit) TFT color LCD. Display 127a may also, if desired, be implemented as a touch-sensitive screen. The volume is adjustable by a volume control 135 and headphones (not shown) may be connected to the GBA via a headphone jack 137. An interface 143 is used for interfacing with, for example, other portable game systems; console game systems such as the GCN (see FIG. 3) connected to televisions or other display devices; external devices such as infrared communication circuits, modems, adapters, bar code readers, wireless telephones microphones and the like.

The GBA is powered by batteries (not shown) contained in a battery compartment accessible via a removable compartment cover 129. Power indicator 131 dims as the batteries lose power to provide a visual indication that new batteries are needed. In an alternative implementation, the GBA may also be configured for connection to an AC adapter to permit play without batteries.

To play a videogame (or use some other application), the user selects an appropriate storage medium storing the videogame (or application) he or she wants to play (or use), and inserts that storage medium into a slot 240 in the GBA. The storage medium may, for example, be in the form of a cartridge housing a memory that stores the game program or application. Such memory is typically semiconductor memory, although optical and magnetic memories are also usable. Alternatively, all or a portion of a videogame program may be downloaded to the GBA from a game console such as the GCN through link cable 201 and interface 143. The GBA can be used as a controller for another game console such as the GCN. If a GBA is used as a controller to a videogame executed by the GCN, information provided on display 127a of a particular GBA may be viewable only by the user operating the GBA while information displayed by the television connected to the GCN is viewable by all users.

The user operates a power switch 125b to turn on the GBA and cause the GBA to begin running the videogame or application based on the program stored in the storage medium or downloaded from a game console via interface 143. Of course, it is also possible to provide electrical power from the GCN if the GBA is connected to the GCN or to provide some games and/or applications in on-board memory of the GBA. Such games and applications may be accessible without inserting a storage medium into slot 240.

Operating keys 133a-133g are used to provide inputs to the GBA. These inputs may be transmitted to the GCN via link cable 201. Operating keys 133a and 133b are used, for example, to cause various motions and actions of the game characters (i.e., gameplayers) displayed on LCD 127a. These motions and actions include equipment (e.g., baseball bat) use, a jump and the like. Operating key 133c is used to move a game character displayed on LCD 127a in four directions, e.g., upward, downward, right and left. Operating key 133d is a select key that is used, for example, for game mode selection and the like. Operating key 133e is a start key that is used to start playing a game or to temporarily stop the progress of a game. The GBA is also provided with left and right shoulder buttons 133f and 133g for supplying operating signals. When a player holds the GBA during gameplay, operating keys 133a and 133b are accessible by the thumb of the right hand, operating key 133c is accessible by the thumb of the left hand, left shoulder button 133f is accessible by the index finger of the left hand and right shoulder button 133g is accessible by the index finger of the right hand. In this way, a user may supply a variety of inputs to the GBA. Depending upon the particular game or application, the various operating keys 133a-133g can perform different functions at different times.

Other input devices may be used with the GBA. For example, if display 127a is implemented as a touch-sensitive screen, a stylus may be used to supply inputs. Various other input devices may also be connected to the GBA via interface 143 or cartridge slot 240. For example, an infrared communication device may be connected to interface 143 to permit communication with other similarly equipped devices. A modem or network interface may be connected to the GBA via interface 143 or via cartridge slot 240 to permit connection to the Internet. A digital camera may be connected to the GBA via cartridge slot 240 to input captured images. A microphone may be connected to the GBA via cartridge slot 240 or via interface 143 to input audio signals such as the user's voice.

When a game cartridge is inserted into cartridge slot 240, the GBA automatically detects the cartridge type and switches to an appropriate operation mode. More specifically, the GBA includes a connector that, in use, is operatively connected to a portable storage medium (e.g., game cartridges) storing game programs or other applications. The example GBA includes first processing circuitry for processing programs having a first program specification (e.g., an 8-bit specification) and second processing circuitry for processing programs having a second program specification (e.g., 32-bit specification). The automatic detection of cartridge type may, for example, be based on a physical characteristic of the portable storage medium (e.g., shape of cartridge housing) or may be based on data stored in the portable storage medium.

While the example implementations are described with reference to a hand-held game system, many of the concepts are applicable to other computing systems such as personal digital assistants (PDAs). For example, it may be desirable to configure a PDA to be compatible with a wide range of accessories, not all of which conform to the same specifications. By using the cartridge type detection techniques described herein and/or by providing first and second processing circuitry as described herein, the number and type of accessories that may be used with the PDA may be increased.

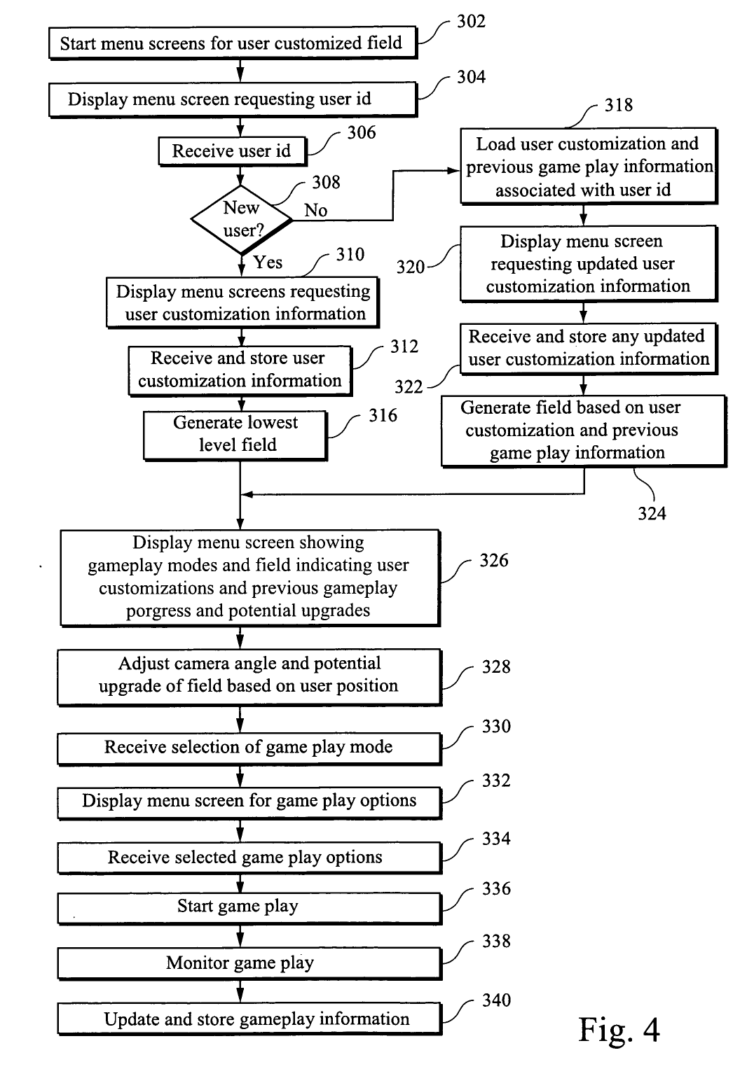

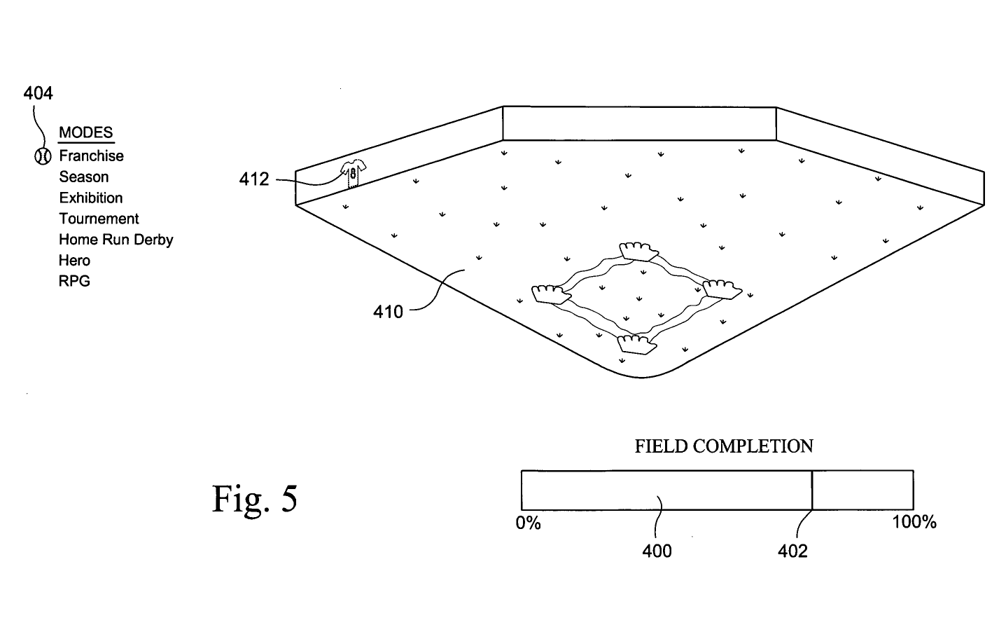

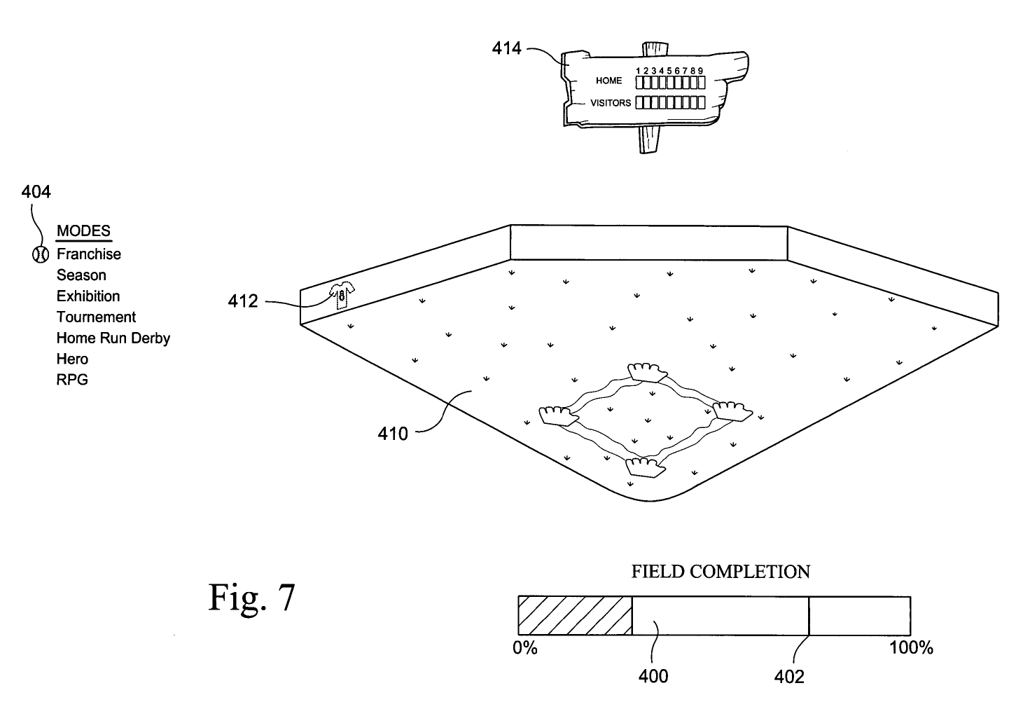

A videogame being executed by console 10 may be controlled by a videogame player(s) via one or more controllers 20 (see FIG. 1) and/or one or more of GBA controllers (see FIG. 3). In accordance with an exemplary implementation, the videogame player(s) can set up play in a baseball videogame as illustrated by the method shown in the flow diagram of FIG. 4 and corresponding screen shots of FIGS. 5-10.

FIGS. 4-10 describe a sports videogame in accordance with an exemplary implementation which generates and displays a playing area having upgrade features customized to the user's tastes. The upgrade features are incrementally earned by the videogame player through gameplay such as gameplay of the videogame in different gameplay modes. While FIGS. 4-10 describe a baseball videogame which generates and displays a playing field having user customized upgrades earned through gameplay, the exemplary implementation is suitable in any sports videogame which is played on a playing surface such as a field, rink, court or stadium.

A videogame player may initiate menu screens for generating and displaying a playing field having user customized features in accordance with an exemplary implementation by manipulating an appropriate button, switch and/or joystick on the controller such as controller 20 or GBA controller. Controller output generated from the player's manipulation of the controller is received by the videogame to start menu screens necessary for generating and displaying the user customized playing field (step 302 of FIG. 4). Alternatively, the menu screens necessary for generating and displaying the user customized playing field may be started by default during initial booting of the videogame.

The videogame generates and displays a menu screen requesting the videogame player to provide a user id (step 304). The videogame player manipulates an appropriate button, switch and/or joystick on the controller to enter a user id. The videogame receives controller output reflecting the user id (step 306). This user id associates user customization information and gameplay information with a particular videogame player.

The videogame determines whether the user is new (step 308). The videogame accomplishes this determination by checking to see whether the received user id matches any previously stored user id. Previously stored user ids are stored in a memory medium such as a memory card (or any other suitable medium such as CD, DVD or cartridge used to store the videogame software or another storage medium which may be received by the platform executing the videogame).

If the user is new (“Yes” in step 308), the videogame generates and displays menu screens requesting user customization information (step 310). For example, the menu screens ask the videogame player to input his/her name and any athletic accomplishments such as any championships won and may ask for his/her favorite colors, teams and players. The videogame player enters such information by manipulating the controller in an appropriate manner. The videogame receives the entered user customization information and stores this information on the same storage medium storing the videogame software or on another storage medium (step 312).

The videogame is capable of generating and displaying a plurality of different playing fields. For example, in the exemplary baseball videogame described herein, the videogame is capable of generating and displaying the following (exemplary but in no way limiting) playing fields: sandlot, elementary, high school, college, AAA and major league. The level of sophistication of these playing fields increases from the sandlot playing field to the major league playing field. That is, the elementary field is more sophisticated and contains more amenities than the sandlot field, the high school field is more sophisticated and contains more amenities than the elementary field, and so on. Since the videogame player is a new user and thus no previous gameplay is associated with the new user id, the videogame generates for later display the playing field (in this example, the sandlot playing field) corresponding to the lowest level of gameplay progress (step 316).

If the videogame player is not new (“No” in step 308), the videogame loads user customization information and previous gameplay information associated with the received user id (step 318). This user customization and previous gameplay information is stored on the storage medium storing the videogame software or another storage medium. The videogame then generates and displays a menu screen requesting updated user customization information (step 320). The videogame thus gives the user an opportunity to change information relating to his/her favorite colors, teams, players and/or accomplishments. The videogame player enters such updates through manipulation of the controller. The videogame receives and stores any updated user customization information entered by the user (step 322).

The videogame then generates for later display a user customized playing field based on the user customization information and previous gameplay information associated with the user id (step 324). As discussed above, a user customized playing field from one of a number of possible playing fields (sandlot, elementary, high school, college, AAA and major league) is generated based on the user's customization information and previous gameplay (step 324). Which particular one of the possible playing fields is generated indicates the level of gameplay progress made by the videogame player as will be discussed in more detail below.

Each playing field includes user customized upgrade features which may be earned by the videogame player for gameplay of different modes and/or accomplishments within gameplay. For example, an initial sandlot playing field corresponding to the lowest level of gameplay progress merely includes four gloves serving as bases for a baseball game. However, upgrades such as a wooden scoreboard, bleachers for accommodating fans, retired jerseys of favorite players, pennants reflecting past championships, logos and emblems reflecting favorite teams can be earned by the videogame player through gameplay. Other upgrades which may be earned through gameplay in different modes and/or accomplishments within gameplay include, for example, grass on the playing field, a backstop and chalk lines between the bases. When the sandlot playing field is initially generated and displayed to the user, the sandlot field will not include any of these upgrades. However, as the user engages in gameplay of different gameplay modes and/or achieves certain performance goals within gameplay, upgrades are generated and later displayed to the user.

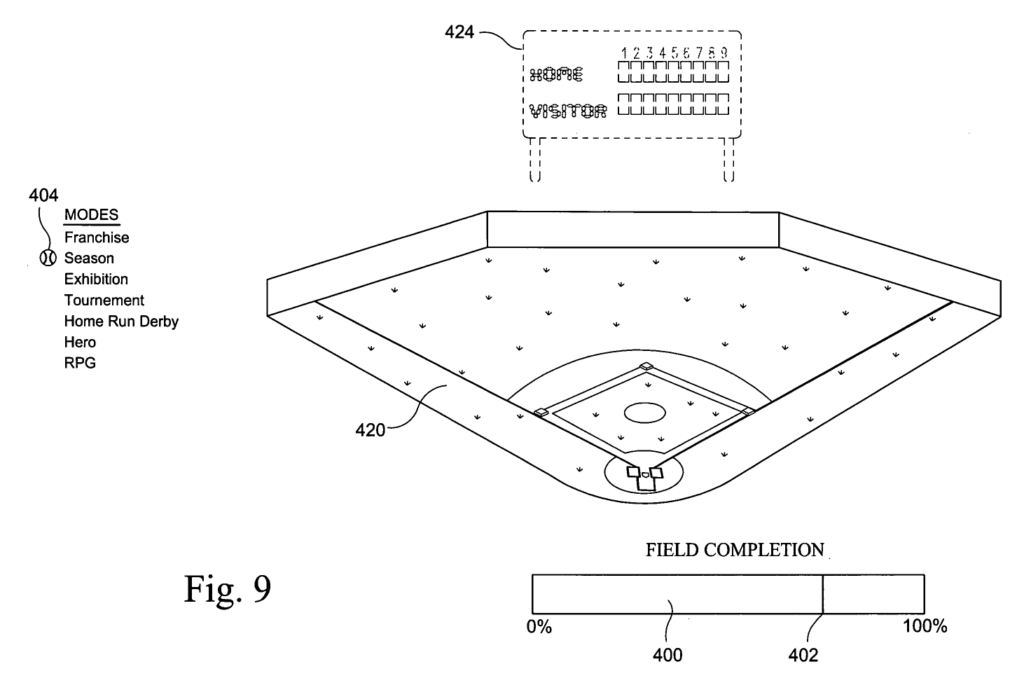

Like the sandlot field, the other playing fields initially do not include all of the upgrade features. For example, the elementary school playing field may initially include only four bases and a pitcher's mound (see FIG. 9). However, the videogame player may earn the upgrade features through gameplay of various gameplay modes and/or achievements within gameplay. The upgrade features may include, for example, paint on the backstop with the videogame player's favorite colors, an electronic scoreboard, double tiered bleachers to accommodate many fans, retired jerseys of favorite players, team pennants, logos and emblems of favorite teams.

At least some of the upgrades that may be earned for the various playing fields are customized specifically to the videogame player's tastes. For example, if the upgrade is a retired jersey, the retired jersey can be that of the videogame player's favorite player. Similarly, if the upgrade is a team pennant hanging in one portion of the playing field, the team pennant may contain the logo or emblem the videogame player's favorite team. Yet another exemplary upgrade may be painting certain portions of the playing field, such as the walls of the playing field, the videogame player's favorite colors. The videogame player's preferences are entered as user customization information in response to menu screens provided by the videogame as described in steps 310 and 318-322 of FIG. 4. The upgrades thus provide an incentive for the videogame player to engage in gameplay in different modes and/or achieve certain performance goals.

At the completion of step 316 or 324, the videogame generates and displays a menu screen showing gameplay modes and one of the playing fields (step 326). The playing field that is displayed is indicative of the progress of previous gameplay accomplished by the videogame player. For example, if the videogame player has not previously played the videogame at all, the playing field displayed will be the playing field corresponding to the lowest level of gameplay progress, i.e., the sandlot playing field 410 as illustrated in FIG. 5. If, however, the videogame player had already engaged in enough gameplay to earn at least a certain percentage of the upgrades in the sandlot field, the next field in the progression (in this case, the elementary field) would be displayed as illustrated in FIG. 9.

As illustrated in FIG. 5, the menu screen includes a list of all of the available modes of gameplay. As can be seen on the left-hand side of the menu screen, the gameplay modes include the following: franchise, season, exhibition, tournament, homerun derby, hero and RPG. The videogame player selects one of the gameplay modes through cursor 404 which may be moved in accordance with the videogame player's manipulation of the controller.

The menu screen also shows a playing field. In this example, it is assumed that the videogame player has not engaged in any previous gameplay (i.e., steps 310-316 are performed) and thus the field that is displayed is a sandlot field 410. The menu screen also includes a field completion meter 400. The field completion meter indicates what percentage of the upgrades for the displayed playing field have already been earned by the videogame player. As can be seen in FIG. 5, the videogame player in this example has not yet earned any upgrades. The sandlot field 410 displayed in the menu screen therefore does not include any upgrades. The field completion meter 400 includes a target field completion percentage 402. This target field completion percentage 402 may be, for example, 80%. Once the user meets the target field completion percentage 402, the user gains the option of actually playing a videogame in the at least nearly completed field and earns the display of the next field (elementary field) in the progression of playing fields ultimately leading to the major league field.

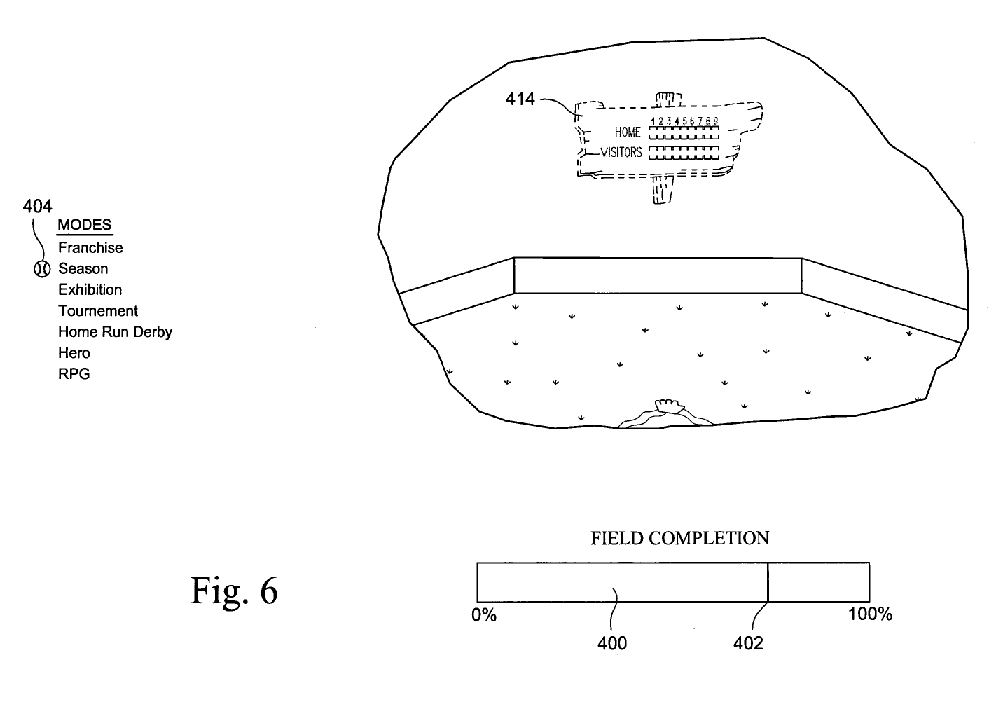

Each of the gameplay modes is associated with a particular upgrade feature. For example, as illustrated in FIG. 5, the franchise gameplay mode is associated with the upgrade feature of a retired jersey 412. As illustrated in FIG. 6, the season mode is associated with the upgrade feature of a wooden scoreboard 414. As the videogame player moves cursor 404 to potentially select a different gameplay mode, the display changes to show the upgrade feature associated with the potentially selected gameplay mode. The potential upgrade feature at that point is shown in shadow to indicate to the player that he/she has not yet earned that upgrade feature, but would do so if he/she begins to play that gameplay mode associated with the upgrade feature. As can be appreciated from FIGS. 5 and 6, the camera angle of the field changes as the videogame player moves cursor 404 from one particular gameplay mode to another to focus on the upgrade feature associated with the gameplay mode next to cursor 404.

The menu screen displayed in FIG. 5 thus shows sandlot field 410 as the initial display field. Since cursor 404 is next to the franchise mode, the menu screen illustrated in FIG. 5 also shows retired jersey 412 in shadow. Retired jersey 412 may reflect the jersey of the videogame player's favorite player which, as discussed above, is entered by the videogame player in response to previous menu screens requesting user customization information (steps 310 and/or 318-322 of FIG. 4).

If the user moves cursor 404 from the franchise mode to the season mode, the menu screen changes from that illustrated in FIG. 5 to that illustrated in FIG. 6. As illustrated in FIG. 6, the sandlot field 410 is still displayed. However, the screen now further shows a wooden scoreboard 414 in shadow rather than the retired jersey 412 in shadow. The videogame player can thus see what upgrade he/she will earn by playing a particular gameplay mode. The videogame player in the foregoing example will earn a retired jersey 412 as an upgrade to field 410 if he/she selects and plays in the franchise mode, but will alternatively earn the wooden scoreboard 414 as an upgrade to field 410 if he/she selects and plays in the season mode. To earn both the retired jersey 412 and the wooden scoreboard 414, the user will ultimately have to play in both the franchise and season modes, although which upgrade jersey 412 or scoreboard 414) is earned first depends on which of the franchise and season modes is played first. Accordingly, the videogame player has an incentive to play both the franchise and season modes since it is only through playing both of these modes that the user can earn both of the upgrades illustrated in FIGS. 5 and 6.

Rather than being a completely new user, assume that the videogame player has instead already played in the season mode. This previous gameplay information associated with the videogame player will be loaded into the videogame in step 318. The user has thus already earned the wooden scoreboard 414 as an upgrade to the sandlot field 410. The menu screen generated and displayed in step 326 thus shows the sandlot field 410 and the wooden scoreboard in detail (no longer in shadow since scoreboard 414 has already been earned rather than just being a potential upgrade). The field completion meter 400 is no longer at 0% since at least one of the upgrades, i.e., the wooden scoreboard 414, has already been earned. Since cursor 404 is next to the franchise mode, retired jersey 412 is shown in shadow (or any other mechanism such as a menu listing to denote a potential upgrade) to indicate that the potential upgrade of a retired jersey can be earned by playing in franchise mode. Unlike the menu screen illustrated in FIG. 5, however, wooden scoreboard 414 is shown in detail since this upgrade feature has already been earned. The user is thus encouraged to play in the franchise gameplay mode in order to earn retired jersey 412 in addition to the already earned wooden scoreboard 414. If the user were to select and play in the franchise mode, retired jersey 412 would be earned. The next time that the user manipulates the controller to initiate the menu screens to display the user customized field or upon booting of the videogame (step 302 begins), playing field 410, wooden scoreboard 414 and retired jersey 412 would be shown in detail in step 326. The field completion meter 400 would also be increased. Since each of the other gameplay modes are associated with additional upgrades, the user is encouraged to play in the other gameplay modes to obtain these additional upgrades.

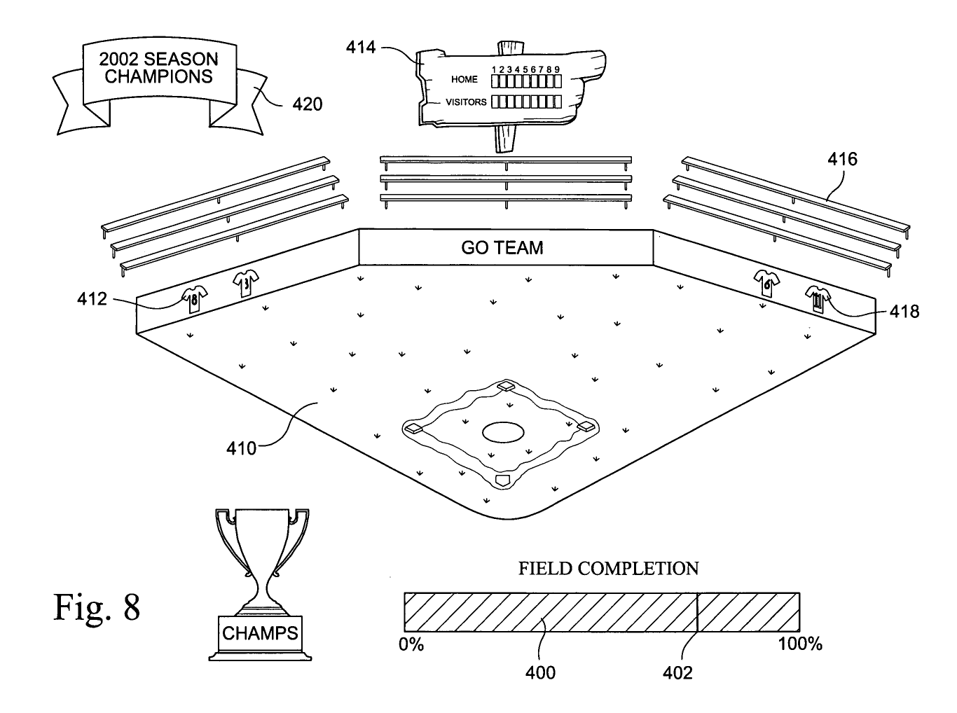

The videogame can also generate and temporarily display the sandlot field as it would appear if all of the upgrades were earned. FIG. 8 illustrates such an “aspirational” playing field having all of the upgrades of the sandlot field including bleachers 416 to accommodate fans, additional retired jerseys 418 and/or championship pennants 420. The videogame can limit the amount of time or the number of instances (e.g., only one instance) that this aspirational field can be shown so as to provide merely a short glimpse of the aspirational field and encourage the user to permanently earn all of the upgrades forming the aspirational field through gameplay. Since the sandlot field shown in FIG. 8 includes all of the upgrades, the field completion meter is at 100%.

The videogame player may select the user customized playing field shown in step 326 in a menu screen as a gameplay option only when the field completion meter 400 has met or passed the target field completion percentage 402. For example, a videogame player with no previous gameplay is not permitted to play a game within the user customized field shown in FIGS. 5-7 immediately. The user customized field is merely shown in the initial menu screens preceding actual gameplay, which occurs in a separate, fully equipped and licensed stadium simulated by the videogame. The videogame player must earn enough of the upgrades through gameplay in order to be able to play a game in the user customized field. That is, the videogame player must earn at least the target field completion percentage of field upgrades before having the option of playing in the user customized field. Prior to that point, the user customized field can only be displayed in menu screens preceding actual play.

FIGS. 5-7 thus illustrate menu screens showing gameplay modes and the user customized field reflecting the previous progress of gameplay associated with the videogame player (step 326). The camera angle and potential upgrades of the user customized field are adjusted as the videogame player moves cursor 404 to different potentially selected gameplay modes (step 328). The adjustment of the camera angle and changes in potential upgrades are shown, for example, as the videogame player moves cursor 404 from the franchise mode to the season mode as illustrated in FIGS. 5-6. The videogame then receives data reflecting the selection of the gameplay mode (step 330) and generates and displays a menu screen for further gameplay options (step 332). These gameplay options may include, for example, prompting the videogame player to indicate what teams he/she would like to play and in what field or stadium he/she would like to play. The videogame receives the selected gameplay options (step 334) and ultimately starts gameplay (step 336).

As discussed above, the gameplay is not necessarily performed in the user customized field. For example, if the field completion meter 400 has not yet reached the target field completion percentage 402, the user is not permitted to select a gameplay option of playing a game in the user customized field. In this instance, the user must play a game in another field, such as any of the major league licensed fields, provided by the videogame. On the other hand, if the videogame player has already earned enough upgrades in a particular user customized field so that the field completion meter meets or exceeds the target completion percentage 402 for that particular field, the user can be presented the gameplay option in step 332 of playing the game in the user customized field which the videogame player has earned.

Gameplay is monitored (step 338). For example, gameplay achievements such as hitting a certain number of home runs and/or winning a certain number of games are monitored. These achievement goals can be associated with further upgrades to the user customized field. For example, a user may receive a certain award plaque as an upgrade to the user customized playing field if he/she wins a certain number of games or hits a certain number of home runs. The user can be informed in advance that this particular upgrade can be earned upon the satisfaction of a particular performance goal. Alternatively, the performance goal and its corresponding upgrade can be completely unknown to the videogame player. If the videogame player satisfies the performance goal, the upgrade to the user customizable field will thus be a surprise to the videogame player the next time menu screens are generated and displayed. The upgrade may be customized to the performance goal. For example, if a videogame player breaks a homerun record of 75 homeruns by hitting a total of 85 homeruns, a sign with “85” will be displayed. During gameplay or at its conclusion, updated gameplay information including, for example, the satisfaction of performance goals associated with upgrades is stored (step 340). In addition, updated gameplay information may be stored at the start of gameplay.

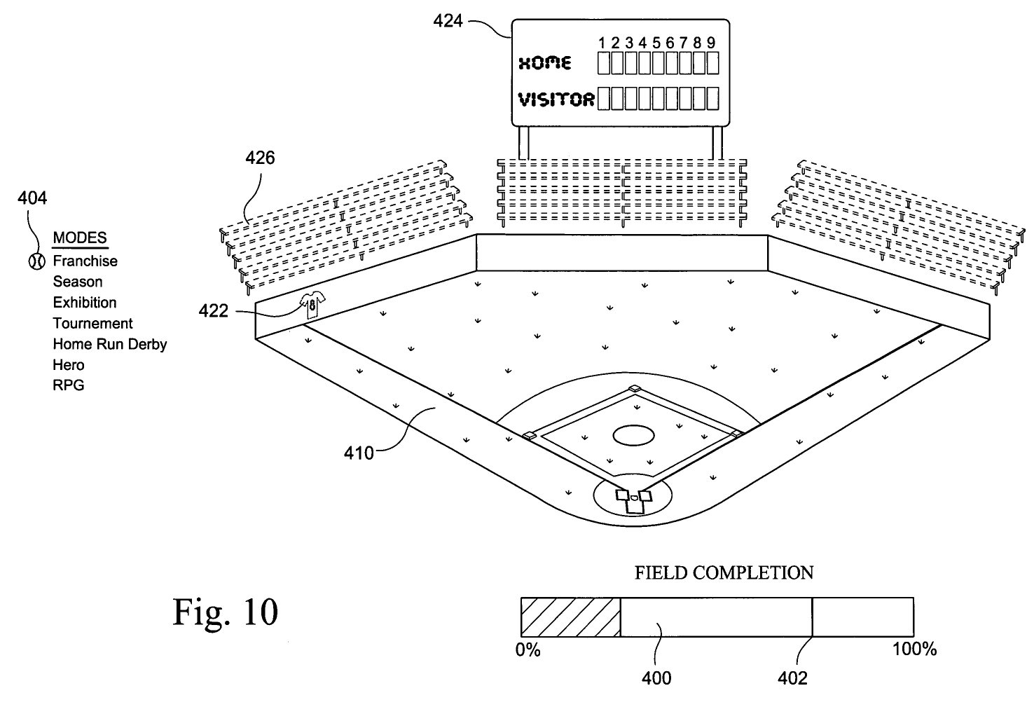

FIGS. 9-10 illustrate different examples of menu screens showing gameplay modes and the user customized field reflecting a different level of previous gameplay progress than that illustrated in FIGS. 5-7. In the example illustrated in FIG. 9, it is assumed that the user has already played in the gameplay modes necessary to earn enough upgrades on the lowest level (sandlot) playing field so that the field completion meter 400 of the sandlot field has met or exceeded the target completion percentage 402. In this example, steps 302-308 are performed as discussed above. Since the user is not a new user, the user customization and previous gameplay information associated with the user id is loaded (step 318). In this example, the previous gameplay information indicates that the sandlot field has already been satisfactorily earned. After steps 320 and 322 are performed, the videogame thus generates and displays the next highest playing field in the progression of playing fields in steps 324-326. The menu screen illustrated in FIG. 9 thus shows an elementary school field 420 rather than a sandlot field 410.

As in the case of the sandlot field, the camera angle and potential upgrades of the elementary school field 420 change based on the position of cursor 404. For example, cursor 404 is next to the season mode and thus a potential upgrade, in this case an electronic scoreboard 424, associated with the season mode is illustrated in shadow along with elementary school field 420. Other potential upgrades would be shown (as discussed above in FIGS. 5-7) as the user moves the cursor 404 to different gameplay modes. The upgrades that may be earned in the elementary school field are not exactly the same as those in the sandlot field. Typically, the upgrades in the elementary school field will be more sophisticated than those of the sandlot field. The elementary school field 420 without any upgrades is typically more sophisticated and offers more amenities than the sandlot field. For example, the elementary school field 420 without any upgrades includes a pitchers mound and four bases. The videogame player may earn the electronic scoreboard 424 based on the selection and play in the season mode. After earning electronic scoreboard 424 as an upgrade, the videogame provides the incentive for the videogame player to play in other modes by providing other upgrades for play in those modes. For example, after already earning electronic scoreboard 424 through play in the season mode, the videogame player may earn a double tiered bleacher 426 having a retired jersey 422 as an upgrade for play in the franchise mode. Retired jersey 422 may again reflect the user's favorite player. The field completion meter 400 in FIG. 10 is no longer at 0% since electronic scoreboard 424 has already been earned. Once the field completion meter 400 of the elementary school field reaches or exceeds target field completion percentage 402, the videogame player will have the gameplay option of playing a baseball game in the upgraded elementary school field (steps 332-334). This videogame player will also already have earned the option of playing a baseball game in the sandlot field.

After the field completion meter 400 of the elementary school field 420 meets or exceeds target field completion percentage 402, the next time the menu screen illustrated as part of step 326 is generated, the next level field (high school playing field) will be displayed. Upgrades for this high school field can then been earned in the manner discussed above with respect to the sandlot and elementary school fields. That is, upgrades to the high school field may be earned by gameplay in different modes and/or satisfying performance goals. After a target percentage of the upgrades in the high school field is earned, the college level field will be displayed and so on. At that point, the user will have the opportunity to select play in either the sandlot, elementary or high school fields as a gameplay option.

The videogame thus provides the videogame player with an incentive to play different gameplay modes. The videogame player will thus be encouraged to explore different aspects of the videogame in which he/she might not have been ordinarily been interested. The videogame player will also be able to see upgrades customized to his/her favorite tastes being added in a step-wise fashion through continued gameplay in different modes and be encouraged to achieve certain performance goals to earn further upgrades. After these fields are completed beyond a target field completion percentage, the videogame player may have the enjoyable experience of playing an actual game in a playing field customized to his/her favorite tastes. Interest in the videogame is therefore increased.

In addition to (or as an alternative to) encouraging the videogame player to play other and all gameplay modes, the videogame may encourage repeat play of the same modes. As an example, a videogame player may play a season in the season mode for the first time and earn five points doing so. The next time he/she plays the season in the season mode, he/she may earn three points (the next time, two points and the next time, one point). If at any time he/she played the exhibition mode for the first time, for example, the videogame player would earn a fresh five points. A videogame player could thus complete the sandlot upgrades after earning a predetermined number of cumulative points by playing only the season mode, although it would take significantly longer than if he/she were to play in multiple modes (e.g., both season and exhibition modes) and would also be unable to acquire certain customizations which are mode specific. If the predetermined cumulative threshold for earning the sandlot field upgrades were ten points for example, the videogame player could meet this cumulative threshold by playing in the season mode once and the exhibition mode once (5 pts+5 pts=10 pts) or alternatively playing in the season mode three separate times (5 pts+3 pts+2 pts=10 pts). While the videogame could thus meet the cumulative point threshold by playing in (only) the season mode three separate times, this would take longer than playing in the season mode once and the exhibition mode once.

As another exemplary embodiment, a videogame player may earn a certain number of points for each performance goal completed. The number of points associated with a completed performance goal may be the same or different than the number of points associated with completion of any other performance goal. The points earned by the videogame player resulting from the completion of performance goals may be accumulated. The opportunity to play in a user customized field having upgrades may be granted to the user when the accumulated points meets or exceeds a threshold number of points. The videogame player will therefore be encouraged to satisfy numerous performance goals. After the user has been awarded a user customized field (i.e., a field having user customized feature(s)), the videogame player may continue to be awarded points for performance goals completed. These awarded points made be accumulated in order to reach another threshold number of points. When the videogame player satisfies this additional threshold, the videogame player will be awarded the opportunity to play a game in another user customized field (e.g., elementary field).

While the above exemplary features describe in the context of a baseball videogame, the exemplary features can be implemented in any suitable sports videogame which is played in a field, rink or court, such as, but not limited to, basketball, soccer, hockey, golf, volleyball and football.

While various implementations of technology are described above, it is to be understood that the invention is not limited to the disclosed implementations, but on the contrary, is intended to cover various modifications and equivalent arrangements included within the spirit and scope of the appended claims.

1. In a sports videogame having a plurality of different gameplay modes, wherein animated action is performed by at least one videogame character in response to input by a user provided through a user-operable controller, a method comprising:
receiving user input on the user-operable controller which selects a particular one of the plurality of gameplay modes, each of the gameplay modes being associated with a respective upgrade to a playing area;
awarding the user an upgrade to the playing area based on the gameplay mode selected by the received user input; and
providing the user the option of engaging in gameplay in which animated action is performed by the videogame character in the playing area having the awarded upgrade.

2. The method of claim 1 wherein the option of engaging in gameplay in which animated action is performed by the videogame character in the playing area having the awarded upgrade is provided only after the user has been awarded at least a predetermined percentage of upgrades to the playing area.

3. The method of claim 1 wherein at least one upgrade relates to a user-customized preference that has been input by the user.

4. The method of claim 3 wherein the user-customized preference that has been input by the user relates to a particular color, sports-team, athlete or athletic accomplishment.

5. The method of claim 1 further comprising generating a display of the playing area showing at least one upgrade awarded to the user prior to providing the user the option of engaging in gameplay using the playing area.

6. The method of claim 1 further comprising generating a display of the playing area showing at least one upgrade which has not been awarded to the user.

7. The method of claim 1, wherein the upgrade to the playing area is awarded to the user only after the user engages in gameplay in the selected gameplay mode.

8. The method of claim 1 further comprising, after the user has been provided the option of engaging in gameplay in which animated action is performed by the videogame character in the playing area having the awarded upgrade:
receiving user input on the user-operable controller which selects a particular one of the plurality of gameplay modes, each of the gameplay modes being associated with a respective upgrade to another playing area;
awarding the user an upgrade to the another playing area based on the gameplay mode selected by the received user input; and
providing the user the option of engaging in gameplay in which animated action is performed by the videogame character in the another playing area having the awarded upgrade to the another playing area.

9. In a sports videogame having a plurality of different gameplay modes, wherein animated action is performed by at least one videogame character in response to input by a user provided through a user-operable controller, a method comprising:
receiving user input on the user-operable controller which selects a particular one of the plurality of gameplay modes, each of the gameplay modes being associated with a respective upgrade to a playing area;
awarding the user an upgrade to the playing area based on the gameplay mode selected by the received user input;
determining whether or not the user has been awarded at least a predetermined number of upgrades to the playing area; and
providing gameplay in which the user controls the videogame character in the playing area having the awarded upgrades so that animated action is performed using the playing area having the awarded upgrades after the determination has been made that the user has been awarded at least the predetermined number of upgrades to the playing area.

10. The method of claim 9 wherein at least one upgrade relates to a user-customized preference that has been input by the user.

11. The method of claim 10 wherein the user-customized preference that has been input by the user relates to a particular color, sports-team, athlete or athletic accomplishment.

12. The method of claim 9 further comprising providing the user an option of engaging in the gameplay in which the user controls the videogame character in the playing area having the awarded upgrades, and generating a display of the playing area showing the upgrades awarded to the user, the display being generated prior to providing the user the option.

13. The method of claim 9 further comprising generating a display of the playing area showing at least one upgrade which has not been awarded to the user.

14. The method of claim 9, wherein the upgrade to the playing area is awarded to the user only after the user engages in gameplay in the selected gameplay mode.

15. The method of claim 9 further comprising:
monitoring for user input on the user-operable controller selecting a particular one of the plurality of gameplay modes, each of the gameplay modes being associated with a respective upgrade to another playing area;
awarding the user an upgrade to the another playing area based on the gameplay mode selected by the received user input;
determining whether or not the user has been awarded at least a predetermined number of the upgrades to the another playing area; and
providing gameplay in which the user controls the videogame character in the another playing area having the awarded upgrades to the another playing area so that animated action is performed by the videogame character in the another playing area after the determination has been made that the user has been awarded at least the predetermined number of upgrades to the another playing area.

16. A method of controlling gameplay in a sports videogame having a plurality of gameplay modes, wherein a user controls a videogame character in response to input by a user provided through a user-operable controller, the method comprising:
receiving user input through the user-operable controller to select a first gameplay mode to enable gameplay in the first gameplay mode;
awarding the user a first upgrade to a playing area based on the selection of the first gameplay mode;
receiving user input through the user-operable controller to select a second gameplay mode to enable gameplay in the second gameplay mode;
awarding the user a second upgrade to the playing area based on the selection of the second gameplay mode; and
providing gameplay in which the user controls the videogame character in the playing area having the first and second upgrades so that animated action is performed by the videogame character in the playing area having the first and second upgrades.

17. The method of claim 16 wherein engaging in the gameplay in which animated action is performed by the videogame character in the playing area having the first and second upgrades is presented to the user as a user-selectable option after the user has been awarded a predetermined number of upgrades to the playing area.

18. The method of claim 16 wherein the first and/or second upgrade relates to a user-customized preference that has been input by the user.

19. The method of claim 18 wherein the user-customized preference that has been input by the user relates to a particular color, sports-team, athlete or athletic accomplishment.

20. The method of claim 16 further comprising providing the user an option of selecting the gameplay in which animated action is performed in the playing area having the first and second upgrades, and generating a display of the playing area showing the first and second upgrades prior to providing the user of the option of selecting the gameplay in which animated action is performed in the playing area having the first and second upgrades.

21. The method of claim 16 further comprising generating a display, prior to providing gameplay in which animated action is performed by the videogame character in the playing area having the first and second upgrades, which shows one or more of the first and second upgrades.

22. The method of claim 16 wherein the first upgrade is awarded to the user only after the user engages in gameplay in the first gameplay mode selected by the user input, and the second upgrade is awarded to the user only after the user engages in gameplay in the second gameplay mode selected by the user input.

23. In a sports videogame having a plurality of different gameplay modes, wherein animated action is performed by at least one videogame character in response to input by a user provided through a user-operable controller, a method comprising:
receiving user input on the user-operable controller selecting one of the plurality of gameplay modes;
awarding the user a predetermined number of point(s) based on each of the gameplay modes selected by the user input;
accumulating the number of points that have been awarded to the user;
determining whether or not the accumulated number of points meets or exceeds a threshold number of points; and
providing the user a gameplay option in which the user controls the videogame character in a playing area having at least one user customized feature if the accumulated number of points meets or exceeds the threshold number of points.

24. The method of claim 23 wherein the number of points awarded to the user based on the user's first selection of a particular one of the gameplay modes is equal to a first number and the number of point(s) awarded to the user based on the user's subsequent re-selection of the same particular one of the gameplay modes is equal to a lesser number points than the first number.

25. The method of claim 23 wherein the number of points awarded to the user based on an initial selection of any one of the gameplay modes is equal to N, and the number of points awarded to the user for a subsequent re-selection of a same one of any of the gameplay modes is equal to M, M being less than N.

26. The method of claim 23 wherein the user customized feature corresponds to a preference input by the user relating to a particular color, sports-team, athlete or athletic accomplishment.

27. In a sports videogame, wherein animated action is performed by at least one videogame character in response to input by a user provided through a user-operable controller, a method comprising:
detecting the user's satisfaction of one of a plurality of gameplay performance goals, each gameplay performance goal being associated with a respective upgrade to a playing area;
awarding to the user the upgrade to the playing area associated to the gameplay performance goal satisfied by the user; and
providing the user the option of engaging in gameplay in which animated action is performed by the videogame character in the playing area having the awarded upgrade.

28. The method of claim 27 wherein the option of engaging in gameplay in which animated action is performed by the videogame character in the playing area having the awarded upgrade is provided only after the user has been awarded a predetermined percentage of upgrades to the playing area.

29. The method of claim 27 wherein at least one upgrade relates to a user-customized preference that has been input by the user.

30. The method of claim 29 wherein the user-customized preference that has been input by the user relates to a particular color, sports-team, athlete or athletic accomplishment.

31. The method of claim 27 further comprising generating a display of the playing area showing the upgrade(s) that have been awarded to the user prior to providing the user the option of engaging in gameplay using the playing area.

32. The method of claim 27 further comprising generating a display of the playing area showing at least one upgrade which has not been awarded to the user.

33. The method of claim 27 further comprising, after the user has been provided the option of engaging in gameplay in which animated action is performed by the videogame character in the playing area having the awarded upgrade:
detecting the user's satisfaction of one of a plurality of gameplay performance goals each of which is associated with a respective upgrade to another playing area;
awarding to the user the upgrade to the another playing area associated to the gameplay performance goal satisfied by the user; and
providing the user the option of engaging in gameplay in which animated action is performed by the videogame character in the another playing area having the awarded upgrade.

34. In a sports videogame, wherein animated action is performed by at least one videogame character in response to input by a user provided through a user-operable controller, a method comprising:
receiving user input on the user-operable controller to control the videogame character in gameplay of the videogame;
determining the user's satisfaction of at least one of a plurality of gameplay performance goals each of which is associated with a respective upgrade to a playing area;
awarding to the user the upgrade to the playing area associated to each gameplay performance goal satisfied by the user;
determining whether or not the user has been awarded a predetermined number of the upgrades to the playing area; and
providing gameplay in which the user controls the videogame character in the playing area having the awarded upgrades so that animated action is performed by the videogame character in the playing area after the determination has been made that the user has been awarded a predetermined number of upgrades to the playing area.

35. The method of claim 34 wherein at least one upgrade relates to a user-customized preference that has been input by the user.

36. The method of claim 35 wherein the user-customized preference that has been input by the user relates to a particular color, sports-team, athlete or athletic accomplishment.

37. The method of claim 34 further comprising providing the user an option of engaging in the gameplay in which the user controls the videogame character in the playing area having the awarded upgrades, and generating a display of the playing area showing the upgrade(s) awarded to the user, the display being generated prior to providing the user the option.

38. The method of claim 34 further comprising generating a display of the playing area showing at least one upgrade which has not been awarded to the user.

39. The method of claim 34 further comprising:
receiving user input on the user-operable controller to control the videogame character in gameplay of the videogame;
determining the user's satisfaction of at least one of a plurality of gameplay performance goals each of which is associated with a respective upgrade to another playing area;
awarding to the user the upgrade to the another playing area associated to each gameplay performance goal satisfied by the user;
determining whether or not the user has been awarded a predetermined number of the upgrades to the another playing area; and
providing gameplay in which the user controls the videogame character in the another playing area having the awarded upgrades so that animated action is performed by the videogame character in the another playing area after the determination has been made that the user has been awarded a predetermined number of upgrades to the another playing area.

40. The method of claim 34 further comprising generating a display of the playing area showing at least one upgrade which has been awarded to the user and at least one upgrade that has not been awarded to the user.

41. A method of controlling gameplay in a sports videogame, wherein a user controls a videogame character in response to input by a user provided through a user-operable controller, the method comprising:
receiving user input on the user-operable controller to control the videogame character in gameplay of the videogame;
determining the user's satisfaction of a first gameplay performance goal;
awarding the user a first upgrade to a playing area based on the user's satisfaction of the first gameplay performance goal;
determining the user's satisfaction of a second gameplay performance goal;
awarding the user a second upgrade to the playing area based on the user's satisfaction of the second gameplay performance goal; and
providing gameplay in which the user controls the videogame character in the playing area having the first and second upgrades so that animated action is performed by the videogame character in the playing area having the first and second upgrades.

42. The method of claim 41 wherein the gameplay in which animated action is performed by the videogame character in the playing area having the first and second upgrades is presented to the user as a user-selectable option after the user has been awarded a predetermined number of upgrades to the playing area.

43. The method of claim 41 wherein the first and/or second upgrade relates to a user-customized preference that has been input by the user.

44. The method of claim 43 wherein the user-customized preference that has been input by the user relates to a particular color, sports-team, athlete or athletic accomplishment.

45. The method of claim 41 further comprising providing the user an option of selecting the gameplay in which animated action is performed in the playing area having the first and second upgrades, and generating a display of the playing area showing the first and second upgrades prior to providing the user of the option of selecting the gameplay.

46. The method of claim 41 further comprising generating a display, prior to providing gameplay in which animated action is performed by the videogame character in the playing area having the first and second upgrades, which shows one or more of the first and second upgrades.

47. In a sports videogame, wherein animated action is performed by at least one videogame character in response to input by a user provided through a user-operable controller, a method comprising:
receiving user input on the user-operable controller to control the videogame character in gameplay of the videogame;
determining the user's satisfaction of at least one of a plurality of gameplay performance goals;
awarding the user a predetermined number of point(s) based on each of the gameplay performance goals satisfied by the user;
accumulating the number of points that have been awarded to the user;
determining whether or not the accumulated number of points meets or exceeds a threshold number of points; and
providing the user a gameplay option in which the user controls the videogame character in a playing area having at least one user customized feature if the accumulated number of points meets or exceeds the threshold number of points.

48. The method of claim 47 wherein the user customized feature corresponds to a preference input by the user relating to a particular color, sports-team, athlete or athletic accomplishment.
